(19) United States
(12) Patent Application Publication
(10) Pub. No.: US 2026/0063815 A1
(43) Pub. Date: Mar. 5, 2026

(54) SYSTEMS AND METHODS FOR REMOTE AUTONOMOUS SEISMIC SOURCES

(71) Applicant: Battelle Memorial Institute, Columbus, OH (US)

(72) Inventors: Richard PARKER, Houston, TX (US); Patrick NORRIS, Upper Arlington, OH (US); James E. RISSER, Lutherville Timonium, MD (US); Matthew D. McCHESNEY, Dallas, TX (US); Nathan CLARK, Columbus, OH (US); Jackson BRENGMAN, Columbus, OH (US); Joseph WOLPERT, Golden, CO (US)

(73) Assignee: BATTELLE MEMORIAL INSTITUTE, Columbus, OH (US)

(21) Appl. No.: 19/312,079

(22) Filed: Aug. 27, 2025

Related U.S. Application Data
(60) Provisional application No. 63/689,088, filed on Aug. 30, 2024.

(51) Int. Cl. G01V 1/147; G01V 1/04; G01V 1/24; G01V 1/30; G01V 1/34

(52) U.S. Cl. CPC G01V 1/147; G01V 1/04; G01V 1/24; G01V 1/30; G01V 1/34; G01V 2210/121; G01V 2210/74

(57) ABSTRACT

A system for providing seismic excitation for subsurface monitoring, the system can include a vertical shaft extending into the ground, an unassisted weight-drop mechanism disposed within the shaft and configured to release a weight from a drop height, where an unassisted weight-drop mechanism disposed within the shaft and configured to release a weight from a drop height, where the unassisted weight-drop mechanism is operably configured to retrieve the weight from the base of the shaft, and raise the weight to the drop height; an engineered impact plate assembly located at the bottom of the vertical shaft to receive the weight; a control box housing control and communications equipment; an energy source coupled to the control box to supply power; and at least one accelerometer positioned to record seismic source characteristics upon the weight's impact. In some embodiments, the seismic source system may be configured to operate autonomously and may be configured to communicate with a monitoring network for performance assessment.

### CROSS-REFERENCE TO RELATED APPLICATIONS

The present application claims priority to U.S. Provisional Application Ser. No. 63/689,088, filed Aug. 30, 2024, entitled “Systems and Methods for Remote Autonomous Seismic Sources.” This application is commonly owned by the owner of the present invention and the content of which is incorporated herein by reference in its entirety for all purposes.

### TECHNICAL FIELD

The present disclosure pertains to the field of subsurface seismic monitoring and, more specifically, to seismic monitoring systems configured for deployment in a variety of geologic and industrial contexts. The invention relates to a novel seismic source system, which is designed for use in monitoring subsurface formations at underground storage sites, hydrocarbon exploration and production sites, and other applications requiring accurate, repeatable seismic excitation. Such applications include, but are not limited to, monitoring, reporting, and verification activities for safe sequestration of gases (for example, carbon dioxide (CO₂)) and characterizing geologic formations in the oil and gas industry.

### STATEMENT OF FEDERALLY FUNDED RESEARCH

None.

### BACKGROUND

The field of carbon capture and storage plays a crucial role in reducing the environmental impacts of carbon dioxide (CO₂) emissions. The Environmental Protection Agency has set stringent guidelines for monitoring, reporting, and verification within designated “Areas of Review” at carbon capture and storage sites to ensure the safe sequestration of CO₂. A critical component of this monitoring involves assessing changes in saturation and pressure within the disposal formations and surrounding rock, especially following CO₂ injection.

One commonly utilized method for this analysis is the active-source, time-lapse, surface seismic reflection technique, which necessitates the excitation of body waves in the subsurface by an artificial seismic source.

Currently available seismic sources capable of long-term, semi-permanent deployment, such as the surface orbital vibrator and electromagnetic linear motors, have inherent limitations. These seismic sources are restricted in the range of frequencies they can produce and typically require a significant energy supply, often necessitating shore power. Furthermore, these systems contain multiple moving parts, which may lead to maintenance challenges and potential variability in seismic source characteristics.

The challenges in the field are numerous. Reliable seismic sources are needed that can operate in remote locations, far from conventional power sources. There is a need for sources that provide a broad range of frequency emissions for accurate subsurface characterization. Moreover, there is a need for systems that are low-maintenance and durable, capable of withstanding harsh environmental conditions without frequent servicing.

In addition, existing seismic sources like surface orbital vibrator and electromagnetic linear motors, which employ a frequency sweep approach, provide only a limited range of frequencies in their emitted energy, thus potentially limiting the scope of data that can be gathered. The energy requirements for such seismic sources are substantial, often necessitating large batteries and significant charging infrastructure. These requirements pose logistical challenges, especially in remote or difficult-to-access carbon capture and storage sites.

Thus, the carbon capture and storage monitoring field is in need of innovative solutions that address these challenges-seismic sources that are energy-efficient, capable of producing a broad spectrum of frequencies, and suitable for long-term deployment in remote areas with minimal maintenance needs. This would significantly enhance the effectiveness and reliability of carbon capture and storage monitoring and compliance with Environmental Protection Agency standards.

### SUMMARY OF THE DISCLOSURE

The present disclosure is directed to a novel seismic source system for subsurface monitoring of underground storage sites, such as for example in carbon capture and storage sites. This system includes an unassisted weight-drop mechanism within a vertical shaft, and an engineered impact plate assembly. In concurrent or alternative embodiments, the impact plate assembly may be configured such that a steel plate is positioned at the bottom of the shaft for efficient energy transfer to the earth. In such embodiments, the configuration of the impact plate assembly may facilitate the replacement of parts worn through use over time. The system may also include a control box equipped with components such as a winch with a permanent electromagnet, power conditioning equipment, and an energy source, which in some embodiments may be a renewable energy source.

To address the needs in the field of underground gas storage monitoring, including in the field of carbon capture and storage site monitoring, the system offers autonomous operation with a flexible power system. In some embodiments the system may be powered by local renewable energy sources, such as solar or wind energy, to facilitate deployment in remote areas. The system, in other embodiments, can accommodate the use of alternative power sources, including shore power, where available, offering versatility in various operational environments. The design, as such, reduces reliance on extensive battery systems and facilitates deployment in various settings.

The weight-drop mechanism in the system provides broadband, repeatable seismic excitation, improving the quality and range of subsurface data acquisition. In certain embodiments, the control box of the system can autonomously schedule and carry out seismic excitation events, ensuring consistent and reliable data collection without manual intervention.

Accordingly, in certain embodiments, the system allows for advanced seismic monitoring capabilities at carbon capture and storage sites. The design, featuring low power requirements and a reduced number of moving parts, enables operation in remote locations, lowers maintenance needs and extends the lifespan of the system. This represents a cost-effective, environmentally sustainable alternative to traditional seismic sources, marking a significant advancement in carbon capture and storage site monitoring technology. The autonomous nature and broadband excitation capabilities of the system enable a more comprehensive analysis of subsurface changes at carbon capture and storage sites, essential for effective CO₂ sequestration monitoring and environmental safeguarding.

In general, in one embodiment, the disclosure features a seismic source system employed for providing seismic excitation for subsurface monitoring. This system may include a vertical shaft that extends into the ground. Within this shaft, an unassisted weight-drop mechanism can be disposed, configured to release a weight from a drop height. An impact plate assembly, located at the bottom of the vertical shaft, may receive the weight. Additionally, the system can incorporate a control box, which houses control and communications equipment. An energy source, coupled to the control box, may supply power to the system. The system might also feature at least one accelerometer positioned to record seismic source characteristics upon the weight's impact. This seismic source system is capable of operating autonomously and may be configured to communicate with a monitoring network for carbon dioxide sequestration performance assessment.

In general, in another embodiment, the disclosure features a seismic source system for generating subsurface seismic waves. The system can include a movable weight configured to be dropped from a height within a shaft extending into the ground to impact an underlying surface. The system can include a control mechanism operable to control the movement of the weight and to coordinate the timing of the weight drop. The system can be configured to function autonomously.

In general, in another embodiment, the disclosure features a method of generating seismic waves for monitoring an underground gas storage site. The method can include dropping a weight within a vertical shaft into the ground onto an impact plate assembly to create body waves. The method can also include controlling the drop of the weight via a control box equipped with a winch and permanent electromagnet. The method can also include powering the control box using an energy source. The method can also include recording seismic source characteristics with at least one accelerometer. The method can also include transmitting the recorded characteristics to a monitoring network for analysis.

In general, in another embodiment, the disclosure features a method of monitoring changes in saturation and pressure in a geological formation associated with gas sequestration. The method can include initiating a seismic source from a remote location by triggering a weight-drop mechanism within a sealed vertical shaft. The method can also include capturing the resultant seismic waves with a network of seismometers. The method can also include analyzing the seismic data to assess the integrity and performance of an underground gas storage site.

In general, in another embodiment, the disclosure features a seismic source system for generating seismic waves in subsurface monitoring. The seismic source system can include an impact portion comprising an impact hammer and an impact anvil. The seismic source system can include a retrieval mechanism operable to position the impact hammer and impact anvil within a well casing. The seismic source system can include a control mechanism operable to control the movement of the impact hammer and coordinate the impact event. The seismic source system can include an energy source coupled to the control mechanism to supply power. The seismic source system can be configured to function autonomously.

In another embodiment, the disclosure features a method of generating seismic waves for subsurface monitoring. The method can include positioning an impact portion within a well casing, the impact portion comprising an impact hammer and an impact anvil. The method can include triggering the impact portion from a remote location by releasing the impact hammer to strike the impact anvil, thereby generating seismic waves. The method can include capturing the resultant seismic waves with a network of seismometers. The method can include analyzing the captured seismic data to calculate the force generated at impact based on material properties and geometry of the impact hammer and anvil. The method can include transmitting the analyzed data to a monitoring network for performance assessment of a carbon capture or storage site.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts a schematic diagram of the seismic source system, showing the control unit, solar power source, impact plate assembly, and the weight drop seismic source mechanism, in accordance with certain embodiments of the present disclosure.

FIG. 2 depicts the seismic source system in operation as part of a monitoring network, illustrating the propagation of seismic waves in the subsurface and their use in collecting information about the CO₂ plume, as recorded by a seismometer in a water well monitoring unit, in accordance with certain embodiments of the present disclosure.

FIG. 3 depicts a block diagram of a method for generating seismic waves for monitoring a carbon capture and storage site, in accordance with certain embodiments of the present disclosure.

FIG. 4 depicts a block diagram of a method for monitoring changes in saturation and pressure in a geological formation associated with carbon dioxide sequestration, in accordance with certain embodiments of the present disclosure.

FIGS. 5A-5B depict a drop weight and retrieval mechanism of the seismic source system, in accordance with certain embodiments of the present disclosure. FIG. 5A depicts a perspective view of the drop weight and retrieval mechanism. FIG. 5B depicts a cross-sectional view of the drop weight and retrieval mechanism.

FIG. 6 depicts a schematic diagram of an impact portion of the seismic source system, showing the retrieval mechanism, impact hammer, impact anvil, and bottom hole assembly, in accordance with certain embodiments of the present disclosure.

FIG. 7 depicts a schematic diagram of a retrieval mechanism, in accordance with certain embodiments of the present disclosure.

FIG. 8 depicts a schematic diagram of an impact hammer, in accordance with certain embodiments of the present disclosure.

FIG. 9 depicts a schematic diagram of an impact anvil, in accordance with certain embodiments of the present disclosure.

FIG. 10 depicts a schematic diagram of a bottom hole assembly, in accordance with certain embodiments of the present disclosure.

### NOTATION AND NOMENCLATURE

Various terms are used to refer to particular system components. Different companies may refer to a component by different names-this document does not intend to distinguish between components that differ in name but not function. In the following discussion and in the claims, the terms “including” and “comprising” are used in an open-ended fashion, and thus should be interpreted to mean “including, but not limited to .” Also, the term “couple” or “couples” is intended to mean either an indirect or a direct connection. Thus, if a first device couples to a second device, that connection may be through a direct connection or through an indirect connection via other devices and connections.

The terminology used herein is for the purpose of describing particular example embodiments only, and is not intended to be limiting. Following long-standing patent law convention, the terms “a” and “an” mean “one or more” when used in this application, including the claims.

As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Accordingly, as an example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

The figures presented herein are illustrative and not intended to be drawn to scale. Proportions and relative dimensions in these figures are not necessarily indicative of actual sizes and should not be considered limiting. Variations in size, proportion, and arrangement of components as depicted in these figures are contemplated and within the scope of the disclosure, unless specifically indicated otherwise in the accompanying description.

### DETAILED DESCRIPTION OF THE DISCLOSURE

The present disclosure is directed to a novel seismic source system for subsurface monitoring in carbon capture and storage sites. This system includes an unassisted weight-drop mechanism within a vertical shaft, an engineered impact plate assembly, and a control box equipped with components such as a winch with a permanent electromagnet, power conditioning equipment, and an energy source. In some embodiments, the energy source may be a renewable energy source.

The disclosure provides innovative, sustainable devices, methods, and systems for seismic monitoring in carbon capture and storage sites that address the limitations of prior art by introducing a novel seismic source system. This system can include an unassisted weight-drop mechanism within a vertical shaft, an engineered impact plate assembly at the bottom of this shaft, and a control box housing various essential components such as a winch with a permanent electromagnet, power conditioning equipment, data recorders, and an energy source. The system can operate autonomously, in some instances powered by local renewable energy sources like solar or wind, facilitating deployment in remote areas. The weight-drop mechanism can provide broadband, repeatable seismic excitation, enhancing the quality and scope of subsurface data acquisition and thereby significantly improving the monitoring and analysis capabilities across multiple industries, including but not limited to carbon capture and storage sites.

All subject matter, including descriptions, claims, and figures, disclosed in (i) U.S. Provisional Application Ser. No. 63/689,088, filed Aug. 30, 2024, entitled “Systems And Methods For Remote Autonomous Seismic Sources” to Richard Parker et al.; (ii) U.S. patent application Ser. No. 18/646,196, filed Apr. 25, 2024, entitled “Integrated Monitoring Systems And Methods Relating Thereto” to Richard Parker et al.; (iii) U.S. Provisional Ser. No. 63/498,256, filed Apr. 25, 2023, entitled “Integrated Monitoring Systems And Methods Relating Thereto,” to Richard Parker et al.; (iv) U.S. Provisional Ser. No. 63/498,257 , filed Apr. 25, 2023, entitled “Integrated Monitoring Systems and Methods for Monitoring Deep Subsurface Storage of Natural Gas” to Richard Parker et al.; and (v) PCT PCT/US24/26252, filed Apr. 25, 2024, entitled “Integrated Monitoring Systems and Methods for Monitoring Deep Subsurface Storage of Natural Gas” to Richard Parker et al. are each hereby incorporated by reference in its entirety (hereinafter, collectively referred to as the “Parker Patents”). This incorporation includes, without limitation, the figures and technical descriptions disclosed therein, which form part of the present disclosure.

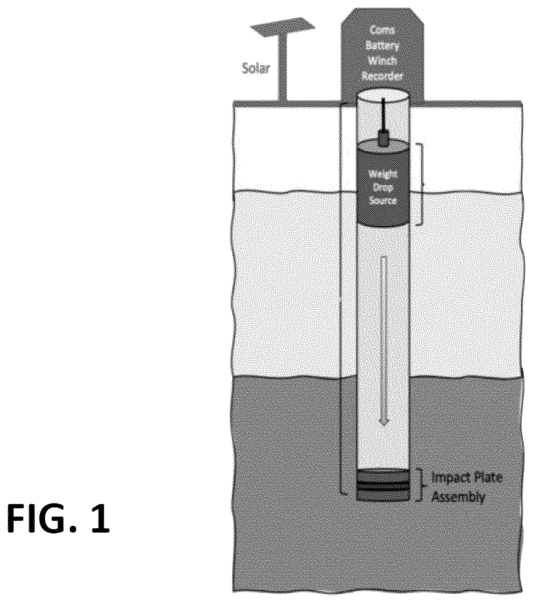

FIG. 1 depicts a schematic diagram of the seismic source system, showing the control unit, solar power source, impact plate assembly, and the weight drop seismic source mechanism, in accordance with certain embodiments of the present disclosure. Specifically, FIG. 1 depicts, in certain embodiments, a seismic source system, which is innovatively designed for subsurface monitoring, especially suitable for applications in carbon capture or storage sites. In some embodiments, this system is capable of providing broadband, repeatable seismic excitation and is uniquely powered by local sources such as solar or wind energy. The system is versatile, functioning either autonomously or with a remote trigger, and is engineered for long-term durability with minimal maintenance requirements.

At the core of the system, as illustrated in FIG. 1, is an unassisted weight-drop seismic source. This component can include a sizable weight, which can vary in mass from approximately 1 to 100 kilograms, suspended in a vertical shaft. In some embodiments, the shaft's depth may extend around 1 to 20 meters into the ground, depending on specific needs or environmental conditions. Positioned at the base of this shaft, in certain embodiments, is an engineered impact plate assembly. Upon release, the weight impacts this assembly, efficiently transferring energy into the subsurface and generating body waves that act as the seismic source. In some embodiments, the drop height of the sizable weight can be in the range of approximately 1 to 20 meters from the engineered impact plate assembly.

The system may also encompass a control box, situated at the surface. This control box can house essential control and communications equipment, including, for example, a winch. Other potential ancillary components housed within the box might include a battery, power conditioning devices, data recorders, and a GPS unit. This setup facilitates the precise control of the weight drop, including timing, data recording, and resetting of the weight after it has been sourced.

In some embodiments, the GPS unit provides time synchronization with a resolution of tenths of milliseconds. In such an embodiment, the precision provided by the GPS unit allows for coordination of time with multiple seismic sensing units, ensuring accurate timing for data recording, weight drop control, and resetting of the weight post-sourcing.

Designed for operation in environments that lack traditional power sources or wired communications, the system's power requirements are relatively low, aligning with its envisaged duty cycle of 1-7 drops per week. In certain embodiments, a small solar panel setup, such as a 100 Ah battery paired with an 85 W solar panel, suffices for powering the system.

The system offers several advantages over prior seismic sources. Its impulsive source design, for instance, allows for a broad range of emitted frequencies, surpassing the band-limited nature of other technologies. Energy efficiency is a key aspect of the system, with its reliance on gravitational potential energy facilitating deployment in remote locations without extensive power infrastructure. Moreover, the system's design simplicity, particularly with fewer moving parts like the winch, results in reduced maintenance needs and a longer lifespan.

Additional features of the system, aimed at ensuring its integrity and optimal performance, can include a full sealing mechanism to prevent water or debris ingress, utilizing nonmagnetic well casing in some embodiments.

In some embodiments, the impact plate assembly may be made of steel, another metal, or combinations thereof. The impact plate assembly can be specifically designed to maximize energy transfer. Further, in some embodiments, the impact plate assembly may have a steel-rubber-steel layered structure. In some embodiments, the impact plate assembly may be configured such that the elastomeric is directly attached to the weight. In concurrent or alternative embodiments, the impact plate assembly may be configured such that a steel plate is positioned at the bottom of the shaft for efficient energy transfer to the earth. In such embodiments, the configuration of the impact plate assembly may facilitate the replacement of parts worn through use over time.

For monitoring and predictive maintenance, an accelerometer may be included in the weight and/or the impact plate assembly in certain embodiments, enabling the quantification of seismic source characteristic and allowing for the identification of variations in the seismic signal, which may be used to indicate potential maintenance needs or the requirement for component replacement, such as the elastomeric in the impact plate assembly.

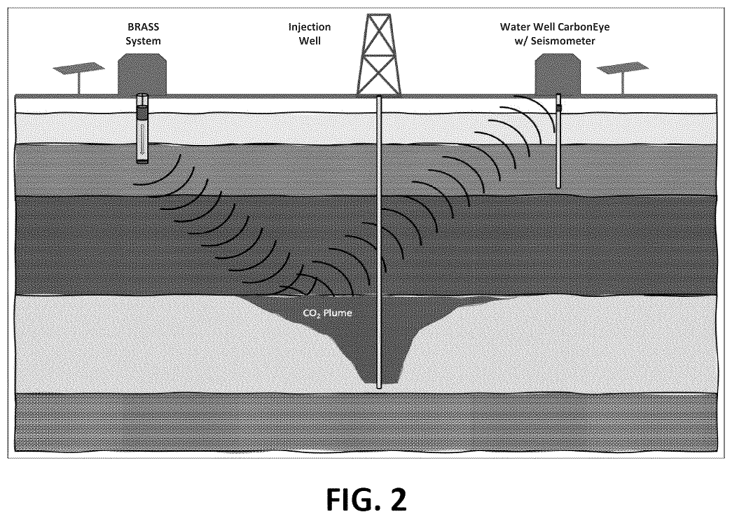

FIG. 2 depicts the seismic source system in operation as part of a monitoring network, illustrating the propagation of seismic waves in the subsurface and their use in collecting information about the CO₂ plume, as recorded by a seismometer in a water well monitoring unit, in accordance with certain embodiments of the present disclosure. FIG. 2 is provided for illustrative purposes and is not necessarily drawn to scale. Proportions and relative dimensions in the figure are not meant to be exact and should not be interpreted as limiting the scope of the invention.

In particular, as shown in FIG. 2, in certain embodiments, the seismic source system can operate as part of a broader monitoring network. This figure demonstrates how the system operates in the context of subsurface wave propagation, particularly focusing on the collection of information about the CO₂ plume. The data gathered by this process can be recorded by a seismometer, which, in some embodiments, could be part of a water well monitoring unit.

In some embodiments, as shown in FIG. 2, the seismic source system may be utilized in conjunction with the inventions disclosed in the Parker Patents.

In this representation, the seismic source system, which can operate on locally sourced power such as solar or wind energy, is shown as part of an integrated network. For example, in some implementations, the system might function autonomously or be triggered remotely, and it is designed for long-term durability with minimal maintenance needs, making it ideal for remote carbon capture or storage sites.

Central to the depicted seismic source system is an unassisted weight-drop mechanism. This mechanism, which may consist of a large weight (such as, for example, but not limited to the weights, equivalent devices, and equivalent mechanisms disclosed in the Parker Patents), is suspended in a vertical shaft. The depth of the shaft and the drop distance of the weight are variable, tailored to achieve optimal energy transfer into the subsurface. While the shaft may extend up to 20 meters into the ground, the actual depth will depend on the need for adequate coupling to the earth. For instance, the shaft might be 10 meters deep, but the weight may only be lifted to a depth of 5 meters for dropping. Conversely, in scenarios like a high water table where deeper shafts are not feasible, the shaft could be shallower, potentially extending a couple of meters above the surface, to provide the required drop distance. As shown by FIG. 2, the bottom of the shaft can include an engineered impact plate assembly that is located to receive the dropped weight. The impact of the weight on this assembly transfers energy into the subsurface, thereby creating body waves that act as a seismic source.

The control aspects of the system are also represented in FIG. 2. In some embodiments, a control box is situated at the surface, housing necessary control and communications equipment, including, for example, a winch. This box might also contain other components such as a battery, power conditioning devices, data recorders, and a GPS unit, as needed. The control box is crucial for the precise operation of the weight drop, including timing, data recording, and resetting the weight after each drop.

Designed for environments lacking conventional power sources, the system's energy needs are modest, aligning with a duty cycle of approximately 1-7 drops per week. A small solar panel system or similar renewable energy source is often sufficient for powering the system. In certain embodiments, the system communicates its readiness to the network after raising the weight, subsequently initiating the source and relaying information to the end user and other network components. The system could also operate with different sensing networks or completely autonomously, following a pre-programmed schedule within the controller.

The seismic source system's design also includes features to optimize its operation and maintain its integrity. For instance, to prevent water or debris ingress, the system may be fully sealed, with the entire subsurface apparatus housed within a nonmagnetic well casing. To ensure the longevity and reliability of the system, particularly in the impact plate assembly, materials such as sturdy polyurethane rubber could be selected. Furthermore, the impact plate assembly itself might be designed with a steel-rubber-steel layered structure, maximizing energy transfer to the ground and minimizing rebound. Additionally, including accelerometers in the weight or the impact plate assembly could be advantageous for quantifying seismic source characteristics and aiding in predictive maintenance.

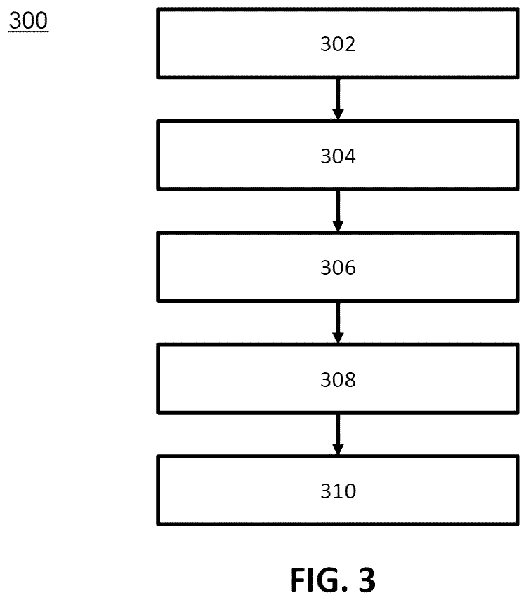

FIG. 3 depicts a block diagram of a method for generating seismic waves for monitoring a carbon capture and storage site, in accordance with certain embodiments of the present disclosure. This method 300 for generating seismic waves, encompasses a series of steps or operations, each represented as a block in the diagram of FIG. 3.

The method 300 begins with dropping a weight. In method 300, the first step 302 involves dropping a weight within a vertical shaft into the ground onto an impact plate assembly to create body waves. In certain embodiments, the weight may vary in mass and is dropped from a predetermined height. In some embodiments, the height that the weight is dropped from is adjustable, allowing drops from different heights. The action of dropping the weight and its impact on the plate assembly generates seismic waves that penetrate the subsurface, essential for monitoring activities.

The method 300 further includes controlling the drop of the weight. This step 304 includes controlling the drop of the weight via a control box. The control box, in some embodiments, is equipped with a winch and a permanent electromagnet. This arrangement allows for precise control over the weight's movement and the timing of its drop, ensuring consistent and accurate generation of seismic waves.

The method 300 further includes powering the control box. The step 306 includes powering the control box using energy sources. For example, the control box may be powered by a combination of solar panels and wind turbines or other renewable energy sources. In some implementations, a battery may be used to store energy from these renewable sources, providing a consistent power supply for the weight-drop mechanism.

The method 300 further includes recording seismic source characteristics. This step 308 involves recording seismic source characteristics with at least one accelerometer. One or more accelerometer may be positioned in various locations, such as within the weight or adjacent to the impact plate, to capture detailed data on the seismic waves generated.

The method 300 further includes transmitting recorded characteristics. Finally, the step 310 includes transmitting the recorded seismic characteristics to a monitoring network for analysis. This transmission enables the collected data to be analyzed and interpreted, providing valuable insights into the subsurface conditions at the carbon capture and storage site.

Additionally, in certain embodiments, the method may include programming the control box to operate on a weekly schedule, executing between 1 and 7 drops per week, as per the specific requirements of the monitoring activity. This scheduling feature allows for regular and systematic data collection, crucial for ongoing assessment of the site.

FIG. 3 represents a comprehensive and adaptable method for generating and utilizing seismic waves in the context of carbon capture and storage site monitoring. This method 300, with its various optional implementations, offers flexibility and efficiency in seismic data acquisition and analysis, aligning with diverse monitoring needs and environmental conditions.

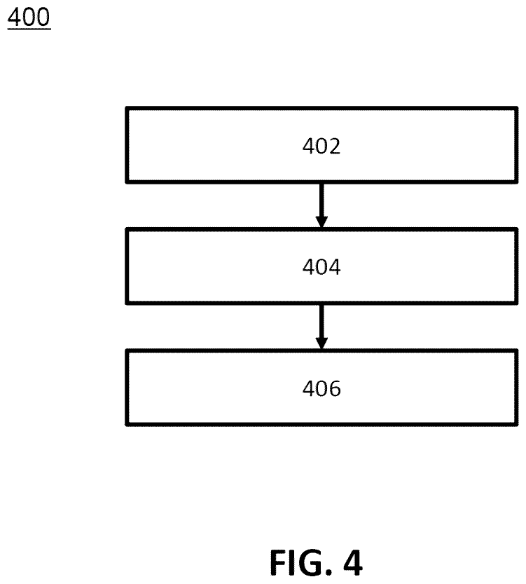

FIG. 4 depicts a block diagram of a method for monitoring changes in saturation and pressure in a geological formation associated with carbon dioxide sequestration, in accordance with certain embodiments of the present disclosure.

In particular, as represented by FIG. 4, the present disclosure presents a method for monitoring changes in saturation and pressure within geological formations, particularly those associated with carbon dioxide sequestration. This method 400 is comprised of several key operations, each represented as a block in the diagram shown in FIG. 4.

The method 400 includes initiating a seismic source. The first step 402 involves initiating a seismic source from a remote location. This can be achieved by triggering a weight-drop mechanism within a sealed vertical shaft. In some embodiments, the weight-drop mechanism can be activated remotely, allowing for the generation of seismic waves from a distance, which is particularly useful in inaccessible or hazardous areas. The vertical shaft is typically sealed to protect the mechanism and ensure accurate seismic wave generation.

The method 400 further includes capturing seismic waves. After the seismic source is initiated, step 404 includes capturing the resultant seismic waves using a network of seismometers. These seismometers, which may be strategically placed around the carbon capture or storage site, detect the seismic waves as they propagate through the subsurface. In certain embodiments, this network can be extensive, covering a wide area to ensure comprehensive data collection.

The method 400 further includes analyzing seismic data. The final step 406 involves analyzing the seismic data collected by the seismometers. This analysis is crucial for assessing the integrity and performance of the carbon capture or storage site. It helps in understanding changes in saturation and pressure within the geological formation. In some embodiments, advanced analytical techniques and software could be employed to interpret the seismic data, providing insights into the subsurface conditions and the efficacy of the carbon sequestration process.

Additionally, in certain embodiments, the method 400 may include using a battery to store energy from renewable energy sources. This stored energy is then used in the weight-drop mechanism, ensuring continuous and reliable operation, especially in remote or off-grid locations.

In some implementations, an accelerometer may be incorporated within the weight or the impact plate assembly. In certain embodiments, the accelerometer can be located on or near the impact plate assembly mechanisms to measure source characteristics. In some embodiments, the accelerometer may be a geophone seismic sensor. The accelerometer provides valuable feedback for predictive maintenance, ensuring the smooth functioning of the seismic source mechanism.

Furthermore, in certain embodiments, the seismic waves generated and captured by this method 400 could be utilized to create time-lapse images of the geological formation. These time-lapse images are particularly useful for monitoring the distribution and movement of sequestered carbon dioxide, offering a dynamic view of the carbon sequestration process and its effectiveness over time.

FIG. 4 represents a method 400 encompassing a series of sophisticated operations for effectively monitoring critical parameters in carbon capture and storage sites. This method, with its various optional components and implementations, provides a versatile and comprehensive approach to subsurface monitoring, aligning with the diverse needs of carbon sequestration projects.

In some embodiments, the remote autonomous seismic source system can include an impact portion in accordance with the embodiments depicted in FIGS. 1 and 2.

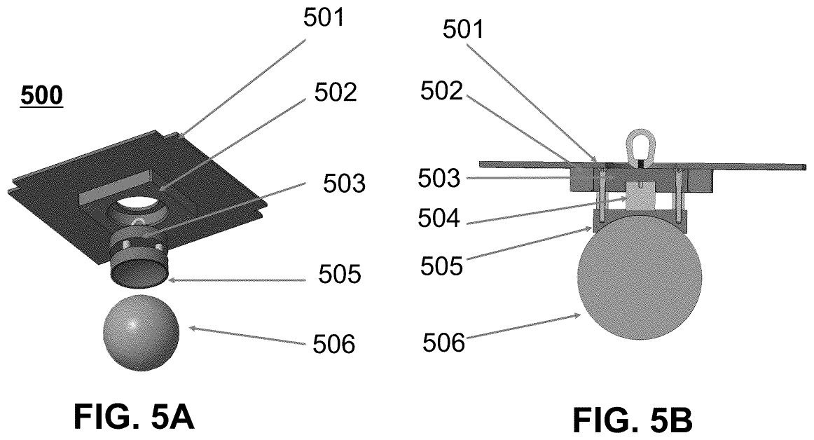

For example, as depicted in FIGS. 5A and 5B, an impact portion 500 of the seismic source system can include a retrieval mechanism and drop weight. In some embodiments, such as for example the embodiment depicted in the impact portion 500 of FIGS. 5A and 5B, the retrieval mechanism can be comprised of a baseplate or stopping component 501, a locating plate 502, a top tag mount 503, a magnet 504, and a pole piece 505. In some embodiments, such as the embodiment depicted in the impact portion 500 of FIGS. 5A and 5B, the retrieval mechanism can be operably configured to release a drop weight 506. Further, in some embodiments, such as the embodiment depicted in the impact portion 500 of FIGS. 5A and 5B, the retrieval mechanism can be operably configured to bring the drop weight 506 back to the baseplate or stopping component 501, which can be situated at a desired drop height. In certain embodiments, the magnet 506 can be brought back to the baseplate or stopping component 501 using the magnet 504.

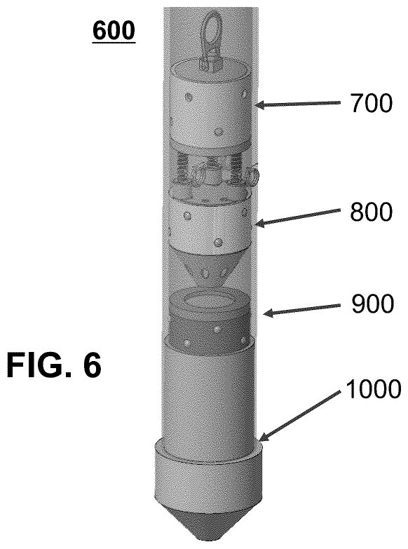

Additionally, for example, FIG. 6 depicts a schematic diagram of an impact portion 600 of the seismic source system, showing the retrieval mechanism 700, impact hammer 800, impact anvil 900, and bottom hole assembly 1000, in accordance with certain embodiments of the present disclosure. In certain embodiments, the impact portion 600 generates an impact force.

The impact portion can be used to generate a force through an impact. The conversion of impact energy in Joules into force in Newtons is dependent on material properties and geometry of the hammer and anvil. For an efficient transfer of energy to force it is important to have a high coefficient of restitution. A high coefficient of restitution involves selection of materials that have high elasticity, high hardness, high resilience, high density, low damping, spherical hammer impacting surface, and smooth hammer and anvil. Accordingly, in various embodiments the materials for the hammer and anvil in the impact portion can include, but are not limited to, 300 series stainless steel, 17-7 PH stainless steel, D2 tool steel, and titanium, bulk metal glass (e.g., a form of amorphous metallic glass), or combinations thereof. The force generated may be then be monitored to discern source characteristics. In some embodiments, an accelerometer can be located on or near the impact portion to measure these source characteristics.

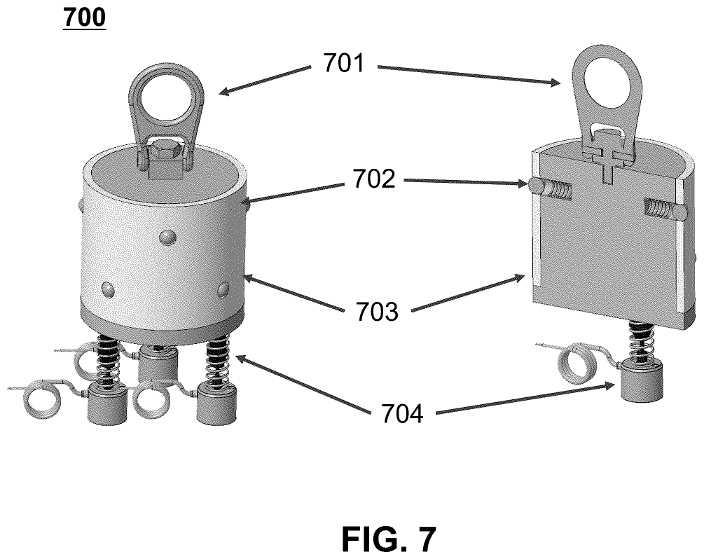

FIG. 7 depicts a schematic diagram of a retrieval mechanism 700, in accordance with certain embodiments of the present disclosure. As shown in FIG. 7, in certain embodiments, the retrieval mechanism 700 can include a lifting eye 701. Thus, in the seismic source system, the retrieval mechanism 700 can be tethered to a winch that allows it to be raised and lowered through the well casing. The retrieval mechanism 700 can further include spring and ball bearings 702 that can be used to center the retrieval mechanism 700 in the well casing. The retrieval mechanism 700 can be surrounded in a PTFE sleeve 703, which in some embodiments may include air holes to allow for optimized free fall. In some embodiments, the retrieval mechanism may have one or more permanent electromagnets 704 on the bottom. The one or more permanent electromagnets 704 can be an array, which can in certain embodiments be attached by springs and dampers. In certain embodiments, one or more permanent electromagnets 704 can be located on an articulating mount to account for any misalignment in the seismic source system.

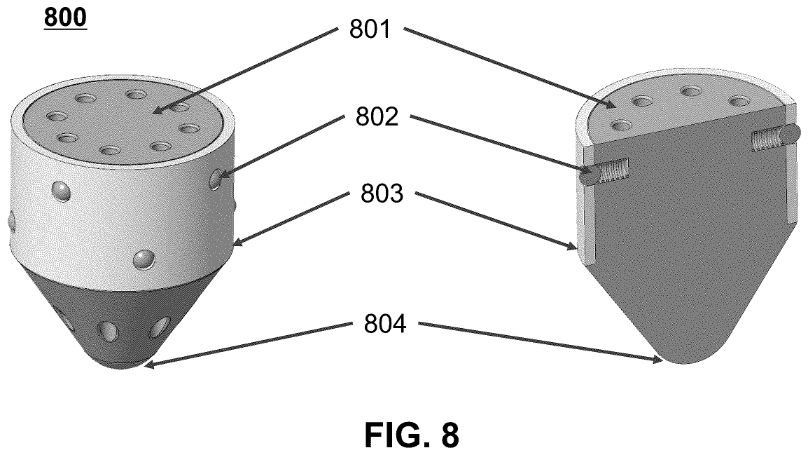

FIG. 8 depicts a schematic diagram of an impact hammer, in accordance with certain embodiments of the present disclosure. The exemplary impact hammer 800, as shown in FIG. 8, can include a body 801. The body 801 can be magnetic so that the impact hammer 800 can be retrieved with a magnet. In some embodiments, the body 801 can be comprised of one or more metals. In certain embodiments, the body 801 can include air flow holes to facilitate an improved free fall. In some embodiments, the impact hammer 800 can include a spring and ball bearing 802 centered in a well casing. In such embodiments, the impact hammer 800 can be aligned to the inner diameter of the well casing through the use of spring and ball bearings 802. In certain embodiments, the impact hammer 800 can include a PTFE outer jacket 803, also referred to as a sleeve, around the body 801. The impact hammer 800 can also, in some embodiments, have a rounded impacting nose 804. In certain embodiments, the impacting nose 804 can be spherical and smooth. In some embodiments, the impacting nose 804 can be replaceable. In such an embodiment, the replaceable impacting nose 804 can be changed out during maintenance.

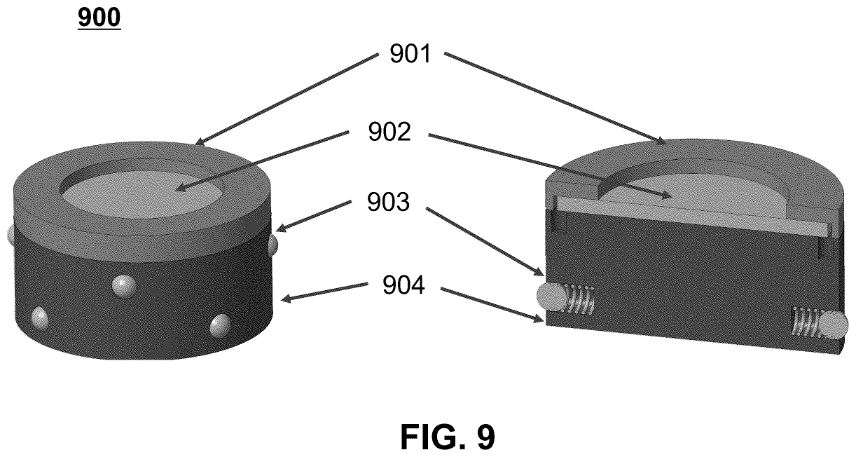

FIG. 9 depicts a schematic diagram of an impact anvil 900, in accordance with certain embodiments of the present disclosure. In some embodiments, such as the embodiment depicted in FIGS. 6 and 9, the impact anvil 900 can include a round plate 902 contained within a housing 904. The housing 904 may be metallic and magnetic. In some embodiments, the impacting surface of the round plate 902 can be configured such that it can be easily replaced during routine maintenance on the seismic source system. The round plate 902 may be situated under a metallic, magnetic top flange 901. In certain embodiments, the impact anvil 900 can further include spring and ball bearings 903 to center the impact anvil 900 in the well casing. As shown in FIG. 9, in certain configurations, the impact anvil 900 may be retrieved with the retrieval mechanism 700.

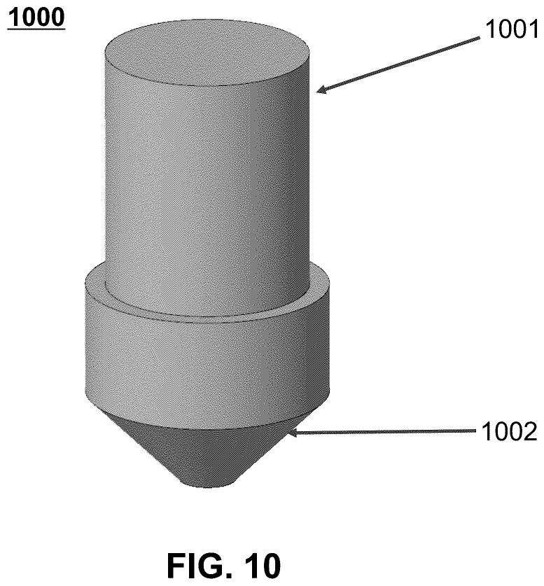

FIG. 10 depicts a schematic diagram of a bottom hole assembly 1000, in accordance with certain embodiments of the present disclosure. The bottom hole assembly 1000 can be situated at the bottom of the well casing. As shown in FIG. 10, the bottom hole assembly 1000 can include a threaded top 1001 to seal on the well casing. As further shown in FIG. 10, the bottom hole assembly 1000 can also include a conical bottom 1002. In some embodiments, the conical bottom 1002 of the bottom hole assembly 1000 can couple the seismic source system to the bedrock. The conical bottom 1002 of the bottom hole assembly 1000 can further, in certain embodiments, produce a point source for the force signal.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that although the previous paragraphs relate to embodiments where steps may be described as occurring in a certain order, no ordering is required unless otherwise stated. In fact, steps described in the previous paragraphs may occur in any order. Furthermore, although one step may be described in one figure and another step may be described in another figure, embodiments of the present disclosure are not limited to such combinations, as any of the steps described above may be combined in particular embodiments.

Those skilled in the art will further appreciate that although the examples described above relate to embodiments where an artificial intelligence infrastructure supports the execution of machine learning models, the artificial intelligence infrastructure may support the execution of a broader class of Artificial Intelligence algorithms, including production algorithms. In fact, the steps described above may similarly apply to such a broader class of AI algorithms.

Those skilled in the art will further appreciate that although the embodiments described above relate to embodiments where the artificial intelligence infrastructure includes one or more storage systems and one or more GPU servers, in other embodiments, other technologies may be used. For example, in some embodiments the GPU servers may be replaced by a collection of GPUs that are embodied in a non-server form factor. Likewise, in some embodiments, the GPU servers may be replaced by some other form of computer hardware that can execute computer program instructions, where the computer hardware that can execute computer program instructions may be embodied in a server form factor or in a non-server form factor.

Example embodiments are described largely in the context of a fully functional computer system. Those having skill in the art will recognize, nonetheless, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present disclosure.

Embodiments can include a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electro-magnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electro-magnetic waves, electro-magnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus, systems, systems-of-systems, and computer program products according to some embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.

Clause 1. A seismic source system for providing seismic excitation for subsurface monitoring, including a vertical shaft extending into the ground, where the vertical shaft has a base; an unassisted weight-drop mechanism disposed within the shaft and configured to release a weight from a drop height, where an unassisted weight-drop mechanism disposed within the shaft and configured to release a weight from a drop height, where the unassisted weight-drop mechanism is operably configured to retrieve the weight from the base of the shaft, and raise the weight to the drop height; an impact plate assembly located at the bottom of the vertical shaft to receive the weight; a control box housing control and communications equipment; and an energy source coupled to the control box to supply power.

Clause 2. The seismic source system of any foregoing clause, further including at least one accelerometer positioned to record seismic source characteristics upon the weight's impact.

Clause 3. The seismic source system of any foregoing clause, where the seismic source system operates autonomously.

Clause 4. The seismic source system of any foregoing clause, where the seismic source system is configured to communicate with a monitoring network.

Clause 5. The seismic source system of any foregoing clause, where the monitoring network is configured for carbon dioxide sequestration performance assessment.

Clause 6. The seismic source system of any foregoing clause, where the monitoring network is configured for enhanced oil recovery performance assessment.

Clause 7. The seismic source system of any foregoing clause, where the weight-drop mechanism is adjustable to release the weight from varying heights within specified ranges.

Clause 8. The seismic source system of any foregoing clause, where the impact plate assembly comprises an elastomeric material attached to the weight and a single piece of steel at the bottom of the shaft.

Clause 9. The seismic source system of any foregoing clause, where the weight is within an adjustable range, subject to variation based on site-specific requirements.

Clause 10. The seismic source system of any foregoing clause, where the vertical shaft facilitates a drop height for the weight relative to the impact plate, which can be adjusted within a range.

Clause 11. The seismic source system of any foregoing clause, where the weight is within a range of 1 to 100 kilograms.

Clause 12. The seismic source system of any foregoing clause, where the drop height is in the range of approximately 1 to 20 meters from the engineered impact plate assembly.

Clause 13. The seismic source system of any foregoing clause, where the unassisted weight-drop mechanism includes a winch with one or more of an electromagnet, a mechanical claw, or combination thereof, where the electromagnet, the mechanical claw, or the combination thereof is operably configured to lift and release the weight.

Clause 14. The seismic source system of any foregoing clause, where the communications equipment includes one or more of a battery, power conditioning equipment, data recorders, and a global positioning system (GPS).

Clause 15. The seismic source system of any foregoing clause, wherein the energy source comprises a renewable energy source.

Clause 16. The seismic source system of any foregoing clause, where the renewable energy source includes one or more of a solar panel or a wind turbine.

Clause 17. A seismic source system for generating subsurface seismic waves, including a movable weight configured to be dropped from a height within a shaft extending into the ground to impact an underlying surface; and a control mechanism operable to control the movement of the weight and to coordinate the timing of the weight drop, where the system is configured to function autonomously.

Clause 18. The seismic source system of any foregoing clause, where the movable weight is within a range of 1 to 100 kilograms.

Clause 19. The seismic source system of any foregoing clause, further including an impact plate assembly located at a lower end of the shaft, configured to receive the weight.

Clause 20. The seismic source system of any foregoing clause, where the movable weight is within an adjustable range, subject to variation based on site-specific requirements.

Clause 21. The seismic source system of any foregoing clause, where the control mechanism comprises a control box housing control and communications equipment.

Clause 22. The seismic source system of any foregoing clause, where the control box includes a winch system with an electromagnet configured to lift and release the weight.

Clause 23. The seismic source system of any foregoing clause, where t the control mechanism is powered by a renewable energy source.

Clause 24. The seismic source system of any foregoing clause, where the renewable energy source includes at least one of a solar panel or a wind turbine.

Clause 25. The seismic source system of any foregoing clause, further including at least one accelerometer to record seismic source characteristics.

Clause 26. The seismic source system of any foregoing clause, where the system is configured to perform within a designated area in a carbon capture or storage site.

Clause 27. The seismic source system of any foregoing clause, where the system is designed for a duty cycle of 1-7 drops per week.

Clause 28. A method of generating seismic waves for monitoring an underground gas storage site, the method including dropping a weight within a vertical shaft into the ground onto an impact plate assembly to create body waves; controlling the drop of the weight via a control box equipped with a winch and permanent electromagnet; powering the control box using an energy source; recording seismic source characteristics with at least one accelerometer; and transmitting the recorded characteristics to a monitoring network for analysis.

Clause 29. The method of any foregoing clause, where the energy source for the control box includes renewable energy sources.

Clause 30. The method of any foregoing clause, where the weight is raised to a drop height solely by power supplied from one or more of a solar panel or a wind turbine.

Clause 31. The method of any foregoing clause, further including using a battery to store energy from the energy sources for use in the weight-drop mechanism.

Clause 32. The method of any foregoing clause, where the control box is programmed to operate on a weekly schedule, executing between 1 and 7 drops per week.

Clause 33. A method of monitoring changes in saturation and pressure in a geological formation associated with gas sequestration, including initiating a seismic source from a remote location by triggering a weight-drop mechanism within a sealed vertical shaft; capturing the resultant seismic waves with a network of seismometers; and analyzing the seismic data to assess the integrity and performance of an underground storage site.

Clause 34. The method of any foregoing clause, further including using a battery to store energy from an energy source for use in the weight-drop mechanism.

Clause 35. The method of any foregoing clause, where the energy source comprises a renewable energy source.

Clause 36. The method of any foregoing clause, further including using an accelerometer within the weight or impact plate assembly to provide feedback for predictive maintenance.

Clause 37. The method of any foregoing clause, where the seismic waves are utilized to generate a time-lapse image of the geological formation to monitor the distribution and movement of sequestered carbon dioxide.

Clause 38. A seismic source system for generating seismic waves in subsurface monitoring, including an impact portion comprising an impact hammer and an impact anvil; a retrieval mechanism operable to position the impact hammer and impact anvil within a well casing; a control mechanism operable to control the movement of the impact hammer and coordinate the impact event; and an energy source coupled to the control mechanism to supply power.

Clause 39. The seismic source system of any foregoing clause, where the seismic source system is configured to function autonomously.

Clause 40. The seismic source system of any foregoing clause, where the retrieval mechanism comprises a lifting eye, one or more spring and ball bearings, and a PTFE sleeve.

Clause 41. The seismic source system of any foregoing clause, where the impact hammer comprises a metallic body with a PTFE outer jacket, spherical impacting nose, and one or more air flow holes to facilitate an improved free fall.

Clause 42. The seismic source system of any foregoing clause, where the impact anvil comprises a metallic top flange, a replaceable impact anvil plate, one or more spring and ball bearings, and a metallic body.

Clause 43. The seismic source system of any foregoing clause, further including a bottom hole assembly, wherein the bottom hole assembly is positioned at a bottom of the well casing and operably couples the seismic source system to bedrock.

Clause 44. The seismic source system of any foregoing clause, where the bottom hole assembly comprises a threaded top portion and a conical bottom portion.

Clause 45. A method of generating seismic waves for subsurface monitoring, including: positioning an impact portion within a well casing, the impact portion comprising an impact hammer and an impact anvil; triggering the impact portion from a remote location by releasing the impact hammer to strike the impact anvil, thereby generating seismic waves; and capturing the resultant seismic waves with a network of seismometers.

Clause 46. The method of any foregoing clause, further including transmitting the analyzed data to a monitoring network for performance assessment of a storage site.

Clause 47. The method of any foregoing clause, where the impact hammer has a spherical impacting nose and one or more air flow holes.

Clause 48. The method of any foregoing clause, where the spherical impacting nose and the one or more air flow holes facilitate an improved free fall in the well casing.

### REFERENCES

Burnison, S. A., Livers, A. J., Hamling, J. A., Salako, O., & Gorecki, C. D. (2017). Design and implementation of a scalable, automated, semi-permanent seismic array for detecting CO2 extent during geologic CO2 injection. Energy Procedia, 114, 3879-3888.
Burnison, S., Livers-Douglas, A., Barajas-Olalde, C., Jin, L., Vettleson, H., Hamiling, J., & Gorecki, C. (2017). Final report of a scalable, automated, semipermanent seismic array (SASSA) method for detecting CO2 extent during geologic CO2 injection (No. 2017-EERC-12-02). Univ. of North Dakota, Grand Forks, ND (United States). Energy and Environmental Research Center.
Noorlandt, R., Drijkoningen, G., Dams, J., & Jenneskens, R. (2015). A seismic vertical vibrator driven by linear synchronous motors. Geophysics, 80(2), EN57-EN67.
Richards, T., Hunt, J., Barajas-Olalde, C., Leroux, K., Hamling, J., Zandy, A., & Correa, J. (2022). Demonstrating novel monitoring techniques at an ethanol 180,000-MT/YR CCS project in North Dakota. YR CCS project in North Dakota (Oct. 26, 2022).
On cyclic yield strength in definition of limits for characterisation of fatigue and creep behaviour—Scientific Figure, ResearchGate. https://www.researchgate.net/figure/Fitting-of-monotonic-and-cyclic-SSCs-for-a-ASTM-A36-steel-from-21-at-RT-b-AISI-4340_fig2_318421795.
M. R. Loos, J. Yang, D. L. Feke, I. Manas-Zloczower, S. Unal, U. Younes, Enhancement of fatigue life of polyurethane composites containing carbon nanotubes, Composites Part B: Engineering, Volume 44, Issue 1, 2013, Pages 740-744, ISSN 1359-8368, https://doi.org/10.1016/j.compositesb.2012.01.038.

What is claimed is:

1. A seismic source system for providing seismic excitation for subsurface monitoring, comprising:
(a) a vertical shaft extending into the ground, wherein the vertical shaft has a base;
(b) an unassisted weight-drop mechanism disposed within the shaft and configured to release a weight from a drop height, wherein the unassisted weight-drop mechanism is operably configured to:
(i) retrieve the weight from the base of the shaft, and
(ii) raise the weight to the drop height;
(c) an impact plate assembly located at the bottom of the vertical shaft to receive the weight;
(d) a control box housing control and communications equipment; and
(e) an energy source coupled to the control box to supply power.

2. The seismic source system of claim 1 further comprising at least one accelerometer positioned to record seismic source characteristics upon the weight's impact.

3. The seismic source system of claim 1, wherein the seismic source system operates autonomously.

4. The seismic source system of claim 1, wherein the seismic source system is configured to communicate with a monitoring network.

5. The seismic source system of claim 4, wherein the monitoring network is configured for carbon dioxide sequestration performance assessment.

6. The seismic source system of claim 4, wherein the monitoring network is configured for enhanced oil recovery performance assessment.

7. The seismic source system of claim 1, wherein the weight-drop mechanism is adjustable to release the weight from varying heights within specified ranges.

8. The seismic source system of claim 1, wherein the impact plate assembly comprises an elastomeric material attached to the weight and a single piece of steel at the bottom of the shaft.

9. The seismic source system of claim 1, wherein the weight is within an adjustable range, subject to variation based on site-specific requirements.

10. The seismic source system of claim 1, wherein the vertical shaft facilitates a drop height for the weight relative to the impact plate, which can be adjusted within a range.

11. The seismic source system of claim 1, wherein the weight is within a range of 1 to 100 kilograms.

12. The seismic source system of claim 1, wherein the drop height is in the range of approximately 1 to 20 meters from the engineered impact plate assembly.

13. The seismic source system of claim 1, wherein the unassisted weight-drop mechanism comprises a winch with one or more of an electromagnet, a mechanical claw, or combination thereof, wherein the electromagnet, the mechanical claw, or the combination thereof is operably configured to lift and release the weight.

14. The seismic source system of claim 1, wherein the communications equipment comprises one or more of a battery, power conditioning equipment, data recorders, and a global positioning system (GPS).

15. The seismic source system of claim 1, wherein the energy source comprises a renewable energy source.

16. The seismic source system of claim 15, wherein the renewable energy source comprises one or more of a solar panel or a wind turbine.

17. The seismic source system of claim 1, wherein the system is designed for a duty cycle between 1 and 7 drops per week.

18. A seismic source system for generating subsurface seismic waves, comprising:
(a) a movable weight configured to be dropped from a height within a shaft extending into the ground to impact an underlying surface; and
(b) a control mechanism operable to control the movement of the weight and to coordinate the timing of the weight drop, wherein the system is configured to function autonomously.

19. The seismic source system of claim 18, wherein the movable weight is within a range of 1 to 100 kilograms.

20. The seismic source system of claim 18 further comprising an impact plate assembly located at a lower end of the shaft, configured to receive the weight.

21. The seismic source system of claim 18, wherein the movable weight is within an adjustable range, subject to variation based on site-specific requirements.

22. The seismic source system of claim 18, wherein the control mechanism comprises a control box housing control and communications equipment.

23. The seismic source system of claim 22, wherein the control box includes a winch system with an electromagnet configured to lift and release the weight.

24. The seismic source system of claim 18, wherein the control mechanism is powered by a renewable energy source.

25. The seismic source system of claim 24, wherein the renewable energy source comprises at least one of a solar panel or a wind turbine.

26. The seismic source system of claim 18 further comprising at least one accelerometer to record seismic source characteristics.

27. The seismic source system of claim 18, wherein the system is configured to perform within a designated area in a carbon capture or storage site.

28. The seismic source system of claim 18, wherein the system is designed for a duty cycle between 1 and 7 drops per week.

29. A method of generating seismic waves for subsurface monitoring, the method comprising:
(a) dropping a weight within a vertical shaft into the ground onto an impact plate assembly to create body waves;
(b) controlling the drop of the weight via a control box equipped with a winch and permanent electromagnet;
(c) powering the control box using an energy source;
(d) recording seismic source characteristics with at least one accelerometer; and
(e) transmitting the recorded characteristics to a monitoring network for analysis.

30. The method of claim 29, wherein the energy source for the control box includes renewable energy sources.

31. The method of claim 29, wherein the weight is raised to a drop height solely by power supplied from one or more of a solar panel or a wind turbine.

32. The method of claim 29 further including the step of using a battery to store energy from the energy source for use in the weight-drop mechanism.

33. The method of claim 29, wherein the control box is programmed to operate on a weekly schedule, executing between 1 and 7 drops per week.

34. A method of monitoring changes in saturation and pressure in a geological formation associated with gas sequestration, comprising:
(a) initiating a seismic source from a remote location by triggering a weight-drop mechanism within a sealed vertical shaft;
(b) capturing the resultant seismic waves with a network of seismometers; and
(c) analyzing the seismic data to assess the integrity and performance of a underground storage site.

35. The method of claim 34, further including the step of using a battery to store energy from an energy source for use in the weight-drop mechanism.

36. The method of claim 35, wherein the energy source comprises a renewable energy source.

37. The method of claim 34, further comprising the step of using an accelerometer within the weight or impact plate assembly to provide feedback for predictive maintenance.

38. The method of claim 34, wherein the seismic waves are utilized to generate a time-lapse image of the geological formation to monitor the distribution and movement of sequestered carbon dioxide.

39. A seismic source system for generating seismic waves in subsurface monitoring, comprising:
(a) an impact portion comprising an impact hammer and an impact anvil;
(b) a retrieval mechanism operable to position the impact hammer and impact anvil within a well casing;
(c) a control mechanism operable to control the movement of the impact hammer and coordinate the impact event; and
(d) an energy source coupled to the control mechanism to supply power.

40. The seismic source system of claim 39, wherein the seismic source system is configured to function autonomously.

41. The seismic source system of claim 39 further comprising a bottom hole assembly, wherein the bottom hole assembly is positioned at a bottom of the well casing and operably couples the seismic source system to bedrock.

42. The seismic source system of claim 41, wherein the bottom hole assembly comprises a threaded top portion and a conical bottom portion.

43. A method of generating seismic waves for subsurface monitoring, comprising:
(a) positioning an impact portion within a well casing, the impact portion comprising an impact hammer and an impact anvil;
(b) triggering the impact portion from a remote location by releasing the impact hammer to strike the impact anvil, thereby generating seismic waves; and
(c) capturing the resultant seismic waves with a network of seismometers.

44. The method of claim 43 further comprising transmitting the analyzed data to a monitoring network for performance assessment of a storage site.
